(19) United States
(12) Patent Application Publication
(10) Pub. No.: US 2011/0233877 A1
(43) Pub. Date: Sep. 29, 2011

(54) Fastening Flange in a Power Tool

(75) Inventor: Milan Bozic, Solothurn (CH)

(73) Assignee: Robert Bosch GmbH, Stuttgart (DE)

(21) Appl. No.: 13/073,738

(22) Filed: Mar. 28, 2011

(30) Foreign Application Priority Data
Mar. 29, 2010 (DE) 10 2010 003 370.7

(51) Int. Cl. B23Q 3/12; F16D 1/06

(52) U.S. Cl. 279/9.1; 403/335

(57) ABSTRACT

A fastening flange in a power tool for accommodating a tool is provided with a noncircular cross-sectional geometry which has points which rise radially and which are designed in the shape of a circle segment. A connecting line between the centers of adjacent points which are in the shape of a circle segment intersects the outer contour, wherein a tangent to the point at the transition to the connecting contour section encloses an angle with the connecting line. An associated power tool assembly is also disclosed.

This application claims priority under 35 U.S.C. §119 to German patent application no. 10 2010 003 370.7, filed Mar. 29, 2010 in Germany, the disclosure of which is incorporated herein by reference in its entirety.

The disclosure relates to a fastening flange in a power tool.

### BACKGROUND

A fastening flange as a receptacle for fastening a tool to a drive shaft is known from EP 1 213 107 A1, said fastening flange, for the positive-locking rotary connection of the tool to the drive shaft, having a star-shaped outer contour, and a section of the tool being designed so as to correspond to said star-shaped outer contour, such that a torque can be transmitted between drive shaft and tool in the slipped-on state via the positive locking. The star-shaped contour of the fastening flange has a total of six rounded-off points, adjacent points assuming a 60° angle relative to one another. Each two adjacent, rounded-off points are connected by a curvature section which is in the shape of an arc of a circle and which merges continuously into the contour of the rounded-off points. This results overall in an outer contour in the form of a continuously closed curve.

### SUMMARY

The object of the disclosure is to provide a reliable receptacle for connecting between a drive shaft in a power tool and a tool, said receptacle permitting transmission of high drive torques over a long operating period.

This object is achieved according to the disclosure by the features set forth herein.

The fastening flange in a power tool, in particular in a portable power tool, which in particular is driven by an electric motor, serves to accommodate a tool and is provided with a noncircular cross-sectional geometry which has rounded-off points which rise radially relative to an imaginary inner circle and are preferably designed in the shape of a circle segment. Since the points end with a defined radius, increased introduction of force in the region of the points is avoided.

According to the disclosure, a connecting line between the centers of adjacent, rounded-off points defines the outer contour of the points, wherein a connecting contour section directly adjoining a point bears asymptotically against the connecting line. The contours of the point and of the connecting contour section are aligned with one another in such a way that a tangent to the point at the transition to the connecting contour section encloses an angle with the connecting line. This means that the transition between the point and the directly adjoining connecting contour section is effected discontinuously. The angle between the tangent to the point at the transition to the connecting contour section and the connecting line which connects the centers of adjacent points and which defines the connecting contour section can in principle assume values of different size, the angular value being dependent in particular on the number of points in the fastening flange and also on the sector over which the point in the shape of a circle segment extends. For example, if four points are arranged in a distributed manner over the circumference, it is expedient for each point to extend over a sector with an angle of 270°, wherein the tangent to the point at the transition to the connecting contour section and the connecting line enclose an angle of 90° in this case. However, angles greater than or less than 90° are possible in principle.

This embodiment permits simplified manufacture with at the same time a high degree of process reliability. It is for example possible to produce the points in the form of drill holes or by punching. The points can perform the function of positioning holes, as a result of which positional and dimensional tolerances can be better maintained, which is advantageous in the event of distortion of the fastening flange, for example as a result of the production process by deep drawing or embossing. The points also enable guide pins to be accommodated in the tool.

In particular in an embodiment of points in the shape of a circle segment over an angle sector greater than 180°, objects accommodated in the points are secured in a positive-locking manner, irrespective of whether the objects inserted are for example individual components in the form of guide pins or are part of a larger, cohesive structure which extends over the entire cross-sectional geometry including the points. This positive-locking accommodation likewise improves the positioning accuracy. This is also helped by the discontinuous transition between the outer contour of the points and the directly adjoining connecting contour section.

According to an expedient development, the point and the connecting contour section adjoining the point are arranged on opposite sides of the connecting line. The point and the connecting contour section, with respect to the center of the cross-sectional geometry, therefore lie radially on opposite sides of the connecting line.

According to yet another expedient embodiment, the connecting contour section connects a point of the cross-sectional geometry to a prominence directed radially inward. This prominence is provided with a curved contour; in particular, it is designed in the shape of a circle segment, wherein, according to another expedient embodiment, the prominence is defined by an imaginary inner circle about the center of the cross-sectional geometry. The inner circle intersects the contour of the prominence, such that the contour of the prominence deviates from the circle segment shape. The exact position of the prominence as well as the radius of the prominence can be established for the individual tool or individual machine; the same applies to the radius of the points and the radial distance of the points from the center of the cross-sectional geometry. Expediently, however, the prominence has a larger radius than that of the point, and at the same time the point is located at a greater radial distance from the center of the cross-sectional geometry than the prominence.

It may be expedient for a total of two prominences to be provided between two points, wherein if need be a further bulge lies between these two prominences, said bulge either being defined by the connecting line or else having a point which is in the shape of a circle segment and extends beyond the connecting line.

The fastening flange, if need be, can also be used as an adapter for attaching various tools.

### BRIEF DESCRIPTION OF THE DRAWINGS

Further advantages and expedient developments can be seen from the further claims and from the description of the figures and the drawings, in which:

FIG. 1 shows a plan view of a fastening flange in a power tool for accommodating a tool, having a cross-sectional geometry which is intended for accommodating the tool and which has a total of four rounded-off points pointing radially outward,

FIG. 2 shows the fastening flange of FIG. 1 in a perspective view,

FIG. 3 shows an enlarged detail of the fastening flange of FIG. 1 in the region of a rounded-off point,

FIG. 4 shows a detail of a fastening flange in a modified embodiment,

FIG. 5 shows a rounded-off point in the cross-sectional geometry of a fastening flange in yet another embodiment.

In the figures, the same parts are provided with the same reference numerals.

### DETAILED DESCRIPTION

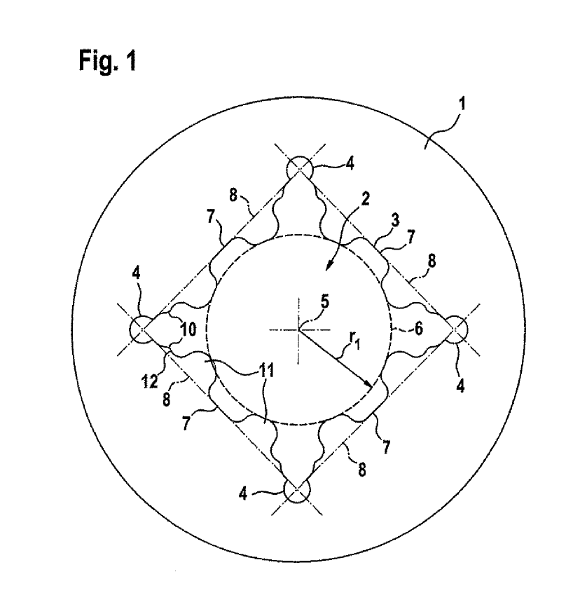

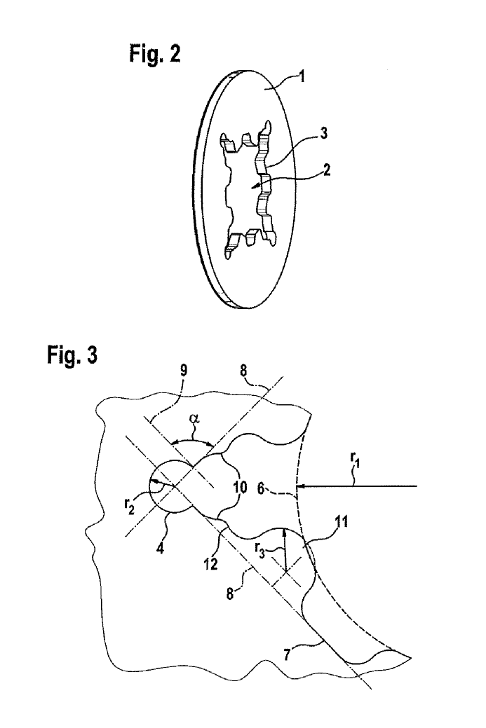

A fastening flange 1 for a motor-driven portable power tool is shown in FIGS. 1 and 2 and is provided with a cross-sectional geometry 2 in the form of a central aperture, the cross-sectional geometry 2 having a noncircular outer contour 3. A corresponding geometry of a workpiece can be inserted into the cross-sectional geometry 2, it being possible, on account of the noncircular outer contour, for a torque to be transmitted to the tool from a drive shaft, to which the fastening flange 1 is fixedly connected.

The cross-sectional geometry 2 has a total of four rounded-off points 4 which are arranged at a 90° angle to one another and extend radially outward relative to a center 5 of the cross-sectional geometry. An enlarged detail of a rounded-off point 5 is shown in FIG. 3, in which the radius of the point 4 in the shape of a circle segment is depicted as r₂.

Relative to an imaginary inner circle 6 about the center 5 with radius r₁, the cross-sectional geometry 2 for accommodating a tool has various bulges directed radially outward; furthermore, the outer contour 3 is provided with prominences 11 which are directed radially inward and which are partly intersected by the inner circle 6. The bulges directed radially outward are in particular the four rounded-off points 4; furthermore, bulges 7 are provided in the middle between two respective points 4, said bulges 7 likewise being directed radially outward and being defined, in the exemplary embodiment, by connecting lines 8 which connect the centers of adjacent points 4 that are in the shape of a circle segment. Respectively adjacent connecting lines 8 are at a 90° angle to one another; the four connecting lines 8 as a whole enclose a square.

The rounded-off points 4 have a circular outer contour which extends over an angular region of 270°. The points 4 are each defined by two connecting lines 8. The transition between the outer contour of the point 4 and the respectively adjacent connecting line 8 is effected discontinuously in such a way that a tangent 9 (FIG. 3) which is drawn to the outer contour of the point 4 in the transition region to the connecting line 8 encloses an angle α with said connecting line 8, which in the exemplary embodiment is 90°. In particular in the case of a different number of points 4 over the periphery of the cross-sectional geometry, the angle α can also assume values different from 90°. For example, if six points 4 are arranged in a distributed manner over the periphery, the angle α is equal to 60°.

The connecting line 8 at the same time forms a tangent for a connecting contour section 10 which is part of the outer contour 3 and directly adjoins the rounded-off point 4. The connecting contour section 10 approaches the connecting line 8 asymptotically in the direction of the point 4.

The connecting contour section 10 is at a smaller radial distance from the center 5 than the points 4.

The connecting contour section 10 connects a respective rounded-off point 4 to a prominence 11, which is arranged between the point 4 and the bulge 7. The prominence 11 is designed in the shape of a circle segment, in particular in a semicircular shape, and has the radius r₃. The prominence 11 is located, just like the connecting contour section 10, on that side of the connecting line 8 which faces the center 5 of the cross-sectional geometry and is thus located on the side opposite the point 4.

The radius r₃ of the prominence 11 is greater than the radius r₂ of the rounded-off point 4. For example, the radius r₃ is twice as large as the radius r₂.

The contour of the prominence 11 is intersected by the inner circle 6, which can be seen in FIGS. 1 and 3 with reference to the broken contour line, which the prominence 11 would have without the intersection by the inner circle 6. The position of the prominence 11 with respect to the inner circle 6 is selected in such a way that only a narrow segment is intersected by the inner circle 6.

A dent-like constriction 12 is located within the connecting contour section 10 between the rounded-off point 4 and the prominence 11, said dent-like constriction 12 being located on the same side of the connecting line 8 as the prominence 11.

With the exception of the discontinuous transition between the point 4 and the connecting contour section 10, all the transitions in the outer contour 3 are designed to be rounded.

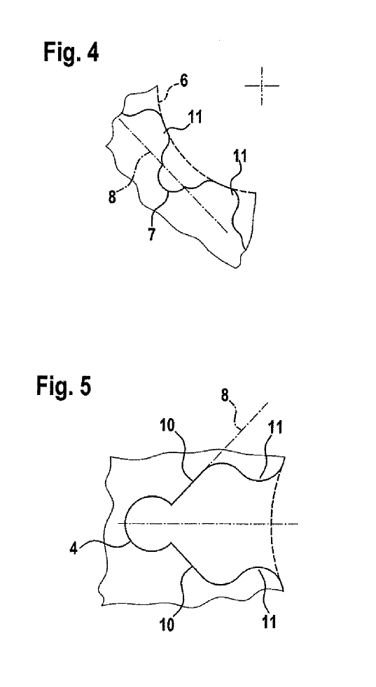

Shown in FIG. 4 is a further exemplary embodiment which corresponds substantially to the first exemplary embodiment but with the difference that the bulge 7 has a point which is in the shape of a circle segment and which is directed radially outward. The point, in the shape of a circle segment, of the bulge 7 is in particular of semicircular design and extends, with respect to the connecting line 8, radially outward. The radius of this bulge 7 in the shape of a circle segment is in particular smaller than the radius of the prominence 11.

In the exemplary embodiment according to FIG. 5, the connecting contour section 10 is designed without a dent-like constriction. That part of the connecting contour section 10 which directly adjoins the rounded-off point is in particular designed to be rectilinear and lies in the connecting line 8.

What is claimed is:

1. A fastening flange for use with a drive member of a power tool and an accessory tool, comprising a noncircular cross-sectional geometry which has points which rise radially and which are rounded-off design, wherein a connecting line between the centers of adjacent rounded-off points intersects the outer contour of the points, and in that a connecting contour section of the cross-sectional geometry, said connecting contour section directly adjoining a point, bears asymptotically against the connecting line in such a way that a tangent to the point at the transition to the connecting contour section encloses an angle (α) with the connecting line.

2. The fastening flange according to claim 1, wherein the point and the connecting contour section adjoining the point lie on opposite sides of the connecting line.

3. The fastening flange according to claim 1, wherein the connecting contour section connects a point of the cross-sectional geometry to a prominence directed radially inward.

4. The fastening flange according to claim 3, wherein the prominence is defined by an imaginary inner circle about the center of the cross-sectional geometry.

5. The fastening flange according to claim 3, wherein the prominence is configured in the shape of a circle segment, the radius (r₃) of the prominence being greater than the radius (r₂) of the point.

6. The fastening flange according to claim 3, wherein two prominences are arranged between two adjacent points.

7. The fastening flange according to claim 6, wherein a bulge lies between adjacent prominences, said bulge being defined by the connecting line.

8. The fastening flange according to claim 6, wherein a bulge lying between adjacent prominences has a point in the shape of a circle segment.

9. The fastening flange according to claim 3, wherein a further prominence lies within the connecting contour section.

10. A power tool assembly, comprising:
a power tool having a drive member;
an accessory tool; and
a fastening flange interposed between the accessory tool and the drive member, wherein the fastening flange comprises a noncircular cross-sectional geometry which has points which rise radially and which are rounded-off design, wherein a connecting line between the centers of adjacent rounded-off points intersects the outer contour of the points, and in that a connecting contour section of the cross-sectional geometry, said connecting contour section directly adjoining a point, bears asymptotically against the connecting line in such a way that a tangent to the point at the transition to the connecting contour section encloses an angle (α) with the connecting line

11. The power tool assembly according to claim 10, wherein the point and the connecting contour section adjoining the point lie on opposite sides of the connecting line.

12. The power tool assembly according to claim 10, wherein the connecting contour section connects a point of the cross-sectional geometry to a prominence directed radially inward.

13. The power tool assembly according to claim 12, wherein the prominence is defined by an imaginary inner circle about the center of the cross-sectional geometry.

14. The power tool assembly according to claim 12, wherein the prominence is configured in the shape of a circle segment, the radius (r₃) of the prominence being greater than the radius (r₂) of the point.

15. The power tool assembly according to claim 12, wherein two prominences are arranged between two adjacent points.

16. The power tool assembly according to claim 15, wherein a bulge lies between adjacent prominences, said bulge being defined by the connecting line.

17. The power tool assembly according to claim 15, wherein a bulge lying between adjacent prominences has a point in the shape of a circle segment.

18. The power tool assembly according to claim 12, wherein a further prominence lies within the connecting contour section.
